(19) United States
(12) Patent Application Publication
(10) Pub. No.: US 2018/0073601 A1
(43) Pub. Date: Mar. 15, 2018

(54) PLANETARY GEAR TRAIN OF AUTOMATIC TRANSMISSION FOR VEHICLE

(71) Applicant: Hyundai Motor Company, Seoul (KR)

(72) Inventors: Wonmin CHO, Hwaseong-si (KR); Seongwook Ji, Gunpo-si (KR); Jae Chang Kook, Hwaseong-si (KR); Seong Wook Hwang, Gunpo-si (KR)

(73) Assignee: Hyundai Motor Company, Seoul (KR)

(21) Appl. No.: 15/265,701

(22) Filed: Sep. 14, 2016

(51) Int. Cl. F16H 3/66

(52) U.S. Cl. CPC F16H 3/66; F16H 2200/2046; F16H 2200/2012; F16H 2200/0065

(57) ABSTRACT

A planetary gear train of an automatic transmission for a vehicle may include an input shaft receiving power of an engine, an output shaft outputting shifted power, a first planetary gear set, a second planetary gear set, a third planetary gear set, a fourth planetary gear set, six control elements disposed at positions to selectively connect the rotation elements to each other or positions to selectively connect at least one of the rotation elements and a transmission housing, a first shaft selectively connectable to the transmission housing, a second shaft selectively connectable to the transmission housing, a third shaft directly connected to the input shaft, a fourth shaft selectively connectable to the transmission housing, a fifth shaft selectively connectable to the third shaft, and selectively connectable to the transmission housing, a sixth shaft directly connected to the output shaft, and a seventh shaft selectively connectable to the third shaft.

### CROSS-REFERENCE TO RELATED APPLICATION

The present application claims priority to Korean Patent Application No. 10-2015-0176089, filed Dec. 10, 2015, the entire contents of which is incorporated herein for all purposes by this reference.

### BACKGROUND OF THE INVENTION

### Field of the Invention

The present invention relates to an automatic transmission for a vehicle. More particularly, the present invention relates to a planetary gear train of an automatic transmission for a vehicle capable of obtaining a power delivery performance improving effect and fuel consumption improving effect through achievement of more shift-stages by implementing nine forward speed shift-stages using as few components as possible, and capable of improving driving silence of the vehicle by using a driving point in a low revolution per minute (RPM) region of an engine.

### Description of Related Art

Recent increases in oil prices are triggering stiff competition in enhancing fuel consumption of a vehicle.

In this sense, research for an engine has been conducted to achieve weight reduction and to enhance fuel consumption by so-called downsizing, and research for an automatic transmission has been made to simultaneously provide better drivability and fuel consumption by achieving more shift-stages.

However, in order to achieve more shift-stages for an automatic transmission, the number of internal components (particularly, planetary gear sets) increase, and as a result, a length of the transmission increases. This may deteriorate installability and/or power flow efficiency and may increase production cost, and weight.

Therefore, it is important to develop a planetary gear train capable of generating maximum efficiency with a small number of parts in order to increase a fuel consumption improvement effect through the achievement of the additional shift-stages.

Recent automatic transmissions have been configured to implement shift-stages of 8-speeds or more and have been installed in the vehicle, and research and development for a planetary gear train capable of implementing shift-stages of 8 shift-stages or more has been actively conducted.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a planetary gear train of an automatic transmission for a vehicle capable of obtaining a power delivery performance improving effect and fuel consumption improving effect through achievement of more shift-stages by implementing nine forward speed shift-stages and a one reverse-speed shift-stage using as few components as possible, and capable of improving driving silence of the vehicle by using a driving point in a low revolution per minute (RPM) region of an engine.

According to various aspects of the present invention, a planetary gear train of an automatic transmission for a vehicle may include an input shaft receiving power of an engine, an output shaft outputting shifted power, a first planetary gear set including first, second, and third rotation elements, a second planetary gear set including fourth, fifth, and sixth rotation elements, a third planetary gear set including seventh, eighth, and ninth rotation elements, a fourth planetary gear set including tenth, eleventh, and twelfth rotation elements, six control elements disposed at positions to selectively connect the rotation elements to each other or positions to selectively connect at least one of the rotation elements and a transmission housing to each other, a first shaft connected to the first rotation element and selectively connectable to the transmission housing, a second shaft connected to the second rotation element and the fifth rotation element and selectively connectable to the transmission housing, a third shaft connected to the third rotation element and the fourth rotation element, and directly connected to the input shaft, a fourth shaft connected to the sixth rotation element and the seventh rotation element, and selectively connectable to the transmission housing, a fifth shaft connected to the eighth rotation element and the twelfth rotation element, selectively connectable to the third shaft, and selectively connectable to the transmission housing, a sixth shaft connected to the ninth rotation element and the eleventh rotation element, and directly connected to the output shaft, and a seventh shaft connected to the tenth rotation element and selectively connectable to the third shaft.

In the first planetary gear set which may be a single pinion planetary gear set, the first rotation element may be a first sun gear, the second rotation element may be a first planet carrier, and the third rotation element may be a first ring gear, in the second planetary gear set which may be a single pinion planetary gear set, the fourth rotation element may be a second sun gear, the fifth rotation element may be a second planet carrier, and the sixth rotation element may be a second ring gear, in the third planetary gear set which may be a single pinion planetary gear set, the seventh rotation element may be a third sun gear, the eighth rotation element may be a third planet carrier, and the ninth rotation element may be a third ring gear, and in the fourth planetary gear set which may be a single pinion planetary gear set, the tenth rotation element may be a fourth sun gear, the eleventh rotation element may be a fourth planet carrier, and the twelfth rotation element may be a fourth ring gear.

The six control elements may include a first clutch selectively connecting the third shaft and the fifth shaft to each other, a second clutch selectively connecting the third shaft and the seventh shaft to each other, a first brake selectively connecting the first shaft and the transmission housing to each other, a second brake selectively connecting the second shaft and the transmission housing to each other, a third brake selectively connecting the fourth shaft and the transmission housing to each other, and a fourth brake selectively connecting the fifth shaft and the transmission housing to each other.

Shift-stages implemented by selective operation of two of the six control elements may include a forward first shift-stage implemented by operation of the second and fourth brakes, a forward second shift-stage implemented by operation of the second clutch and the fourth brake, a forward third shift-stage implemented by operation of the second clutch and the second brake, a forward fourth shift-stage implemented by operation of the second clutch and the third brake, a forward fifth shift-stage implemented by operation of the second clutch and the first brake, a forward sixth shift-stage implemented by operation of the first and second clutches, a forward seventh shift-stage implemented by operation of the first clutch and the first brake, a forward eighth shift-stage implemented by operation of the first clutch and the third brake, a forward ninth shift-stage implemented by operation of the first clutch and the second brake, and a reverse shift-stage implemented by operation of the first and fourth brakes.

The first, second, third, and fourth planetary gear sets may be disposed in a sequence of the first, second, third, and fourth planetary gear sets, and the shafts may be disposed so that an input may be made from a front of the first planetary gear set and an output may be made to a rear of the fourth planetary gear set.

The first, second, third, and fourth planetary gear sets may be disposed in a sequence of the first, second, fourth, and third planetary gear sets, and may be configured so that an input may be made from a front of the first planetary gear set and an output may be made to a rear of the third planetary gear set.

The first, second, third, and fourth planetary gear sets may be disposed in a sequence of the first, second, third, and fourth planetary gear sets, and may be configured so that an input and an output may be made in the fourth planetary gear set.

A planetary gear train of an automatic transmission for a vehicle may include an input shaft receiving power of an engine, an output shaft outputting shifted power, a first planetary gear set being a single pinion planetary gear set and including first, second, and third rotation elements, a second planetary gear set being a single pinion planetary gear set and including fourth, fifth, and sixth rotation elements, a third planetary gear set being a single pinion planetary gear set and including seventh, eighth, and ninth rotation elements, a fourth planetary gear set being a single pinion planetary gear set and including tenth, eleventh, and twelfth rotation elements, a first shaft connected to the first rotation element and selectively connectable to a transmission housing, a second shaft connected to the second rotation element and the fifth rotation element and selectively connectable to the transmission housing, a third shaft connected to the third rotation element and the fourth rotation element and directly connected to the input shaft, a fourth shaft connected to the sixth rotation element and the seventh rotation element and selectively connectable to the transmission housing, a fifth shaft connected to the eighth rotation element and the twelfth rotation element, selectively connectable to the third shaft, and selectively connectable to the transmission housing, a sixth shaft connected to the ninth rotation element and the eleventh rotation element and directly connected to the output shaft, a seventh shaft connected to the tenth rotation element and selectively connectable to the third shaft, a first clutch selectively connecting the third shaft and the fifth shaft to each other, a second clutch selectively connecting the third shaft and the seventh shaft to each other, a first brake selectively connecting the first shaft and the transmission housing to each other, a second brake selectively connecting the second shaft and the transmission housing to each other, a third brake selectively connecting the fourth shaft and the transmission housing to each other, and a fourth brake selectively connecting the fifth shaft and the transmission housing to each other.

In the first planetary gear set, the first rotation element may be a first sun gear, the second rotation element may be a first planet carrier, and the third rotation element may be a first ring gear, in the second planetary gear set, the fourth rotation element may be a second sun gear, the fifth rotation element may be a second planet carrier, and the sixth rotation element may be a second ring gear, in the third planetary gear set, the seventh rotation element may be a third sun gear, the eighth rotation element may be a third planet carrier, and the ninth rotation element may be a third ring gear, and in the fourth planetary gear set, the tenth rotation element may be a fourth sun gear, the eleventh rotation element may be a fourth planet carrier, and the twelfth rotation element may be a fourth ring gear.

Shift-stages implemented by a selective operation of two of control elements including the two clutches and the four brakes include a forward first shift-stage implemented by operation of the second and fourth brakes, a forward second shift-stage implemented by operation of the second clutch and the fourth brake, a forward third shift-stage implemented by operation of the second clutch and the second brake, a forward fourth shift-stage implemented by operation of the second clutch and the third brake, a forward fifth shift-stage implemented by operation of the second clutch and the first brake, a forward sixth shift-stage implemented by operation of the first and second clutches, a forward seventh shift-stage implemented by operation of the first clutch and the first brake, a forward eighth shift-stage implemented by operation of the first clutch and the third brake, a forward ninth shift-stage implemented by operation of the first clutch and the second brake, and a reverse shift-stage implemented by operation of the first and fourth brakes.

The first, second, third, and fourth planetary gear sets may be disposed in a sequence of the first, second, fourth, and third planetary gear sets, and may be configured so that an input may be made from a front of the first planetary gear set and an output may be made to a rear of the third planetary gear set.

According to various aspects of the present invention, a planetary gear train of an automatic transmission for a vehicle may include an input shaft receiving power of an engine, an output shaft outputting shifted power, a first planetary gear set being a single pinion planetary gear set and including a first sun gear, a first planet carrier, and a first ring gear, a second planetary gear set being a single pinion planetary gear set and including a second sun gear, a second planet carrier, and a second ring gear, a third planetary gear set being a single pinion planetary gear set and including a third sun gear, a third planet carrier, and a third ring gear, a fourth planetary gear set being a single pinion planetary gear set and including a fourth sun gear, a fourth planet carrier, and a fourth ring gear, a first shaft connected to the first sun gear and selectively connectable to a transmission housing, a second shaft connected to the first planet carrier and the second planet carrier and selectively connectable to the transmission housing, a third shaft connected to the first ring gear and the second sun gear and directly connected to the input shaft, a fourth shaft connected to the second ring gear and the third sun gear and selectively connectable to the transmission housing, a fifth shaft connected to the third planet carrier and the fourth ring gear, selectively connectable to the third shaft, and selectively connectable to the transmission housing, a sixth shaft connected to the third ring gear and the fourth planet carrier and directly connected to the output shaft, a seventh shaft connected to the fourth sun gear and selectively connectable to the third shaft, and six control elements disposed at positions to selectively connect the shafts to each other and at positions to selectively connect at least one of the shafts and the transmission housing to each other.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view of a planetary gear train according to various embodiments of the present invention.

FIG. 2 is an operation table of each shift-stage of each control element used in the planetary gear train according to various embodiments of the present invention.

FIG. 3 is a schematic view of a planetary gear train according to various embodiments of the present invention.

FIG. 4 is a schematic view of a planetary gear train according to various embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

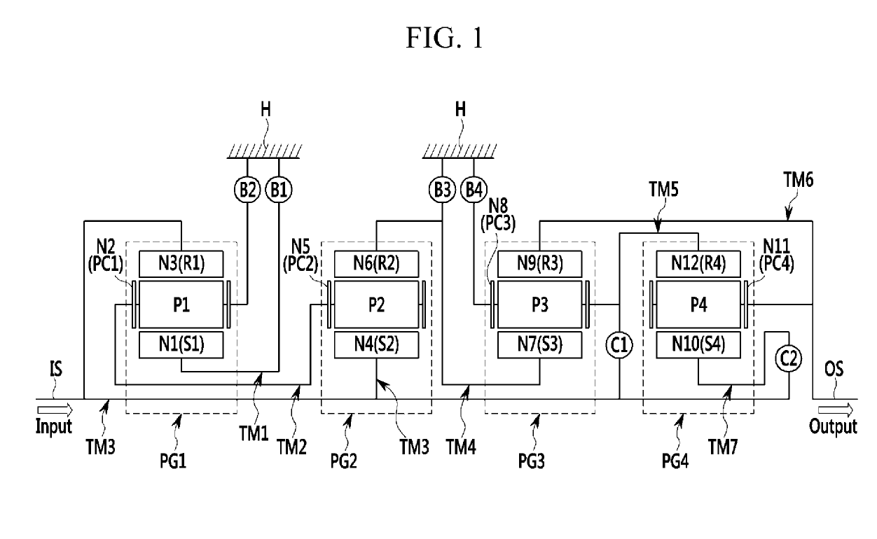

FIG. 1 is a schematic view of a planetary gear train according to a first exemplary embodiment of the present invention.

Referring to FIG. 1, the planetary gear train according to the first exemplary embodiment of the present invention is configured to include first, second, third, and fourth planetary gear sets PG1, PG2, PG3, and PG4 disposed on the same axis, an input shaft IS, an output shaft OS, seven shafts TM1 to TM7 directly connecting the respective rotation elements of the first, second, third, and fourth planetary gear sets PG1, PG2, PG3, and PG4 to each other, six control elements C1 to C2 and B1 and B4, and a transmission housing H.

In addition, rotation power input from the input shaft IS is shifted by a mutual complementing operation between the first, second, third, and fourth planetary gear sets PG1, PG2, PG3, and PG4 and is then output through the output shaft OS.

The respective simple planetary gear sets are disposed in a sequence of the first, second, third, and fourth planetary gear sets PG1, PG2, PG3, and PG4 from an engine side.

The input shaft IS is an input member, and rotation power from a crack shaft of an engine is input to the input shaft after a torque thereof is converted through a torque converter.

The output shaft OS, which is an output member, is disposed on the same axis as an axis on which the input shaft IS is disposed and transfers shifted driving force to a driving shaft through a differential apparatus.

The first planetary gear set PG1, which is a single pinion planetary gear set, includes a first sun gear S1, which is a first rotation element N1, a first planet carrier PC1, which is a second rotation element N2, supporting a first pinion P1 externally engaged with the first sun gear S1, which is the first rotation element N1, and a first ring gear R1, which is a third rotation element N3, internally engaged with the first pinion P1.

The second planetary gear set PG2, which is a single pinion planetary gear set, includes a second sun gear S2, which is a fourth rotation element N4, a second planet carrier PC2, which is a fifth rotation element N5, supporting a second pinion P2 externally engaged with the second sun gear S2, which is the fourth rotation element N4, and a second ring gear R2, which is a sixth rotation element N6, internally engaged with the second pinion P2.

The third planetary gear set PG3, which is a single pinion planetary gear set, includes a third sun gear S3, which is a seventh rotation element N7, a third planet carrier PC3, which is an eighth rotation element N8, supporting a third pinion P3 externally engaged with the third sun gear S3, which is the seventh rotation element N7, and a third ring gear R3, which is a ninth rotation element N9, internally engaged with the third pinion P3.

The fourth planetary gear set PG4, which is a single pinion planetary gear set, includes a fourth sun gear S4, which is a tenth rotation element N10, a fourth planet carrier PC4, which is an eleventh rotation element N11, supporting a fourth pinion P4 externally engaged with the fourth sun gear S4, which is the tenth rotation element N10, and a fourth ring gear R4, which is a twelfth rotation element N12, internally engaged with the fourth pinion P4.

In the first, second, third, and fourth planetary gear sets PG1, PG2, PG3, and PG4, the second rotation element N2 is directly connected to the fifth rotation element N5, the third rotation element N3 is directly connected to the fourth rotation element N4, the sixth rotation element N6 is directly connected to the seventh rotation element N7, the eighth rotation element N8 is directly connected to the twelfth rotation element N12, and the ninth rotation element N9 is directly connected to the eleventh rotation element N11, such that the first, second, third, and fourth planetary gear sets PG1, PG2, PG3, and PG4 are operated while having a total of seven shafts TM1 to TM7.

Configurations of the seven shafts TM1 to TM7 will be described below.

The first shaft TM1 is configured to include the first rotation element N1 (the first sun gear), and is operated as a selective fixed element while being selectively connectable to the transmission housing H.

The second shaft TM2 is configured to include the second rotation element N2 (the first planet carrier PC1) and the fifth rotation element N5 (the second planet carrier PC2), and is operated as a selective fixed element while being selectively connectable to the transmission housing H.

The third shaft TM3 is configured to include the third rotation element N3 (the first ring gear R1) and the fourth rotation element N4 (the second sun gear S2), and is directly connected to the input shaft IS.

The fourth shaft TM4 is configured to include the sixth rotation element N6 (the second ring gear R2) and the seventh rotation element N7 (the third sun gear S3), and is operated as a selective fixed element while being selectively connectable to the transmission housing H.

The fifth shaft TM5 is configured to include the eighth rotation element N8 (the third planet carrier PC3) and the twelfth rotation element N12 (the fourth ring gear R4), and is operated as a selective input element while being selectively connectable to the third shaft TM3 (the input shaft IS).

The sixth shaft TM6 is configured to include the ninth rotation element N9 (the third ring gear R3) and the eleventh rotation element N11 (the fourth planet carrier PC4), and is directly connected to the output shaft OS to thereby be continuously operated as an output element.

The seventh shaft TM7 is configured to include the tenth rotation element N10 (the fourth sun gear S4), and is operated as a selective input element while being selectively connectable to the third shaft TM3 (the input shaft IS).

Two clutches C1 and C2, which are control elements, are disposed at portions of shafts selectively connectable to each other among the shafts TM1 to TM7.

In addition, four brakes B1 to B4, which are control elements, are disposed at portions of shafts selectively connectable to the transmission housing H among the shafts TM1 to TM7.

Positions of the six control elements C1 and C2 and B1 to B4 will be described below.

The first clutch C1 is disposed between the third shaft TM3 (the input shaft IS) and the fifth shaft TM5 to selectively connect the third shaft TM3 (the input shaft IS) and the fifth shaft TM5 to each other.

The second clutch C2 is disposed between the third shaft TM3 (the input shaft IS) and the seventh shaft TM7 to selectively connect the third shaft TM3 (the input shaft IS) and the seventh shaft TM7 to each other.

The first brake B1 is interposed between the first shaft TM1 and the transmission housing H to allow the first shaft TM1 to be operated as a selective fixed element.

The second brake B2 is interposed between the second shaft TM2 and the transmission housing H to allow the second shaft TM2 to be operated as a selective fixed element.

The third brake B3 is interposed between the fourth shaft TM4 and the transmission housing H to allow the fourth shaft TM4 to be operated as a selective fixed element.

The fourth brake B4 is interposed between the fifth shaft TM5 and the transmission housing H to allow the fifth shaft TM5 to be operated as a selective fixed element.

The respective control elements including the first and second clutches C1 and C2 and the first to fourth brakes B1 to B4 may be formed of multi-plate type hydraulic pressure friction-coupled units friction-coupled to each other by hydraulic pressure.

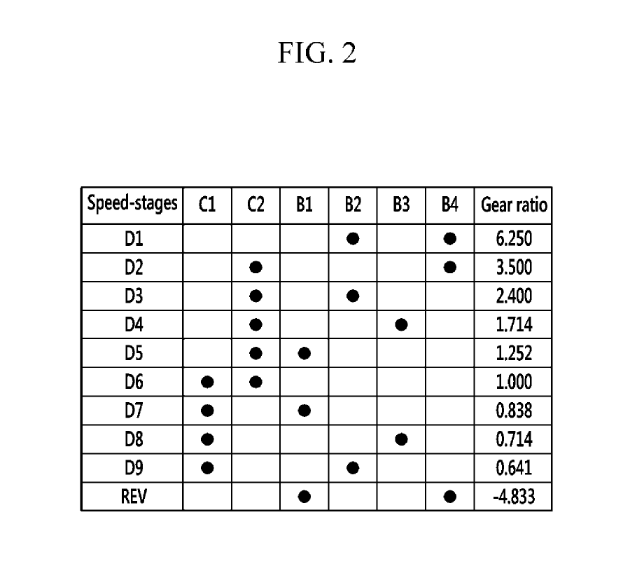

FIG. 2 is an operation table of each shift-stage of each control element used in the planetary gear train according to various embodiments of the present invention.

As shown in FIG. 2, in the planetary gear train according to various embodiments of the present invention, a shift is performed while two control elements being operated in each shift-stage.

In a forward first speed shift-stage D1, the second and fourth brakes B2 and B4 are operated. Therefore, the second shaft TM2 and the fifth shaft TM5 are operated as fixed elements by the operation of the second and fourth brakes B2 and B4 in a state in which an input is made to the third shaft TM3, such that a shift to a forward first speed is made by a complementation operation between the respective shafts and an output is made through the output shaft OS including the sixth shaft TM6.

In a forward second speed shift-stage D2, the second clutch C2 and the fourth brake B4 are operated. Therefore, an input is simultaneously made to the third shaft TM3 and the seventh shaft TM7 in a state in which the third shaft TM3 (the input shaft IS) is connected to the seventh shaft TM7 by the operation of the second clutch C2. In addition, the fifth shaft TM5 is operated as a fixed element by the operation of the fourth brake B4, such that a shift to a forward second speed is made by a complementation operation between the respective shafts and an output is made through the output shaft OS including the sixth shaft TM6.

In a forward third speed shift-stage D3, the second clutch C2 and the second brake B2 are operated. Therefore, an input is simultaneously made to the third shaft TM3 and the seventh shaft TM7 in a state in which the third shaft TM3 (the input shaft IS) is connected to the seventh shaft TM7 by the operation of the second clutch C2. In addition, the second shaft TM2 is operated as a fixed element by the operation of the second brake B2, such that a shift to a forward third speed is made by a complementation operation between the respective shafts and an output is made through the output shaft OS including the sixth shaft TM6.

In a forward fourth speed shift-stage D4, the second clutch C2 and the third brake B3 are operated. Therefore, an input is simultaneously made to the third shaft TM3 and the seventh shaft TM7 in a state in which the third shaft TM3 (the input shaft IS) is connected to the seventh shaft TM7 by the operation of the second clutch C2. In addition, the fourth shaft TM4 is operated as a fixed element by the operation of the third brake B3, such that a shift to a forward fourth speed is made by a complementation operation between the respective shafts and an output is made through the output shaft OS including the sixth shaft TM6.

In a forward fifth speed shift-stage D5, the second clutch C2 and the first brake B1 are operated. Therefore, an input is simultaneously made to the third shaft TM3 and the seventh shaft TM7 in a state in which the third shaft TM3 (the input shaft IS) is connected to the seventh shaft TM7 by the operation of the second clutch C2. In addition, the first shaft TM1 is operated as a fixed element by the operation of the first brake B1, such that a shift to a forward fifth speed is made by a complementation operation between the respective shafts and an output is made through the output shaft OS including the sixth shaft TM6.

In a forward sixth speed shift-stage D6, the first and second clutches C1 and C2 are operated. Therefore, an input is made to the third rotation element TM3 and the seventh rotation element TM7 in a state in which the third shaft TM3 (the input shaft IS) is connected to the fifth shaft TM5 by the operation of the first clutch C1 and the third shaft TM3 (the input shaft IS) is connected to the seventh shaft TM7 by the operation of the second clutch C2. In this case, the first, second, third, and fourth planetary gear sets PG1, PG2, PG3, and PG4 are in a state in which they are directly connected to each other, such that a shift to a forward sixth speed in which an input is output as it is, is made, and an output is made through the output shaft OS including the sixth shaft TM6.

In a forward seventh speed shift-stage D7, the first clutch C1 and the first brake B1 are operated. Therefore, an input is simultaneously made to the third shaft TM3 and the fifth shaft TM5 in a state in which the third shaft TM3 (the input shaft IS) is connected to the fifth shaft TM5 by the operation of the second clutch C2. In addition, the first shaft TM1 is operated as a fixed element by the operation of the first brake B1, such that a shift to a forward seventh speed is made by a complementation operation between the respective shafts and an output is made through the output shaft OS including the sixth shaft TM6.

In a forward eighth speed shift-stage D8, the first clutch C1 and the third brake B3 are operated. Therefore, an input is simultaneously made to the third shaft TM3 and the fifth shaft TM5 in a state in which the third shaft TM3 (the input shaft IS) is connected to the fifth shaft TM5 by the operation of the second clutch C2. In addition, the fourth shaft TM4 is operated as a fixed element by the operation of the third brake B3, such that a shift to a forward eighth speed is made by a complementation operation between the respective shafts and an output is made through the output shaft OS including the sixth shaft TM6.

In a forward ninth speed shift-stage D9, the first clutch C1 and the second brake B2 are operated. Therefore, an input is simultaneously made to the third shaft TM3 and the fifth shaft TM5 in a state in which the third shaft TM3 (the input shaft IS) is connected to the fifth shaft TM5 by the operation of the second clutch C2. In addition, the second shaft TM2 is operated as a fixed element by the operation of the second brake B2, such that a shift to a forward ninth speed is made by a complementation operation between the respective shafts and an output is made through the output shaft OS including the sixth shaft TM6.

In a reverse shift-stage REV, the first and fourth brakes B1 and B4 are operated. Therefore, the first shaft TM1 and the fifth shaft TM5 are operated as fixed elements by the operation of the first and fourth brakes B1 and B4 in a state in which an input is made to the third shaft TM3, such that a reverse shift is made by a complementation operation between the respective shafts and an output is made through the output shaft OS including the sixth shaft TM6.

As described above, the planetary gear train according to various embodiments of the present invention may realize nine forward speed shift-stages and one reverse-speed shift-stage through the four planetary gear sets PG1, PG2, PG3, and PG4 by controlling the operation of the two clutches C1 and C2 and the four brakes B1, B2, B3, and B4.

In addition, the planetary gear train according to various embodiments of the present invention may implement a shift-stage appropriate for a revolution per minute (RPM) of the engine through achievement of more shift-stages of an automatic transmission, thereby making it possible to significantly improve driving silence.

Furthermore, the planetary gear train according to various embodiments of the present invention may maximize driving efficiency of the engine and improve power delivery performance and fuel consumption through the achievement of more shift-stages of the automatic transmission.

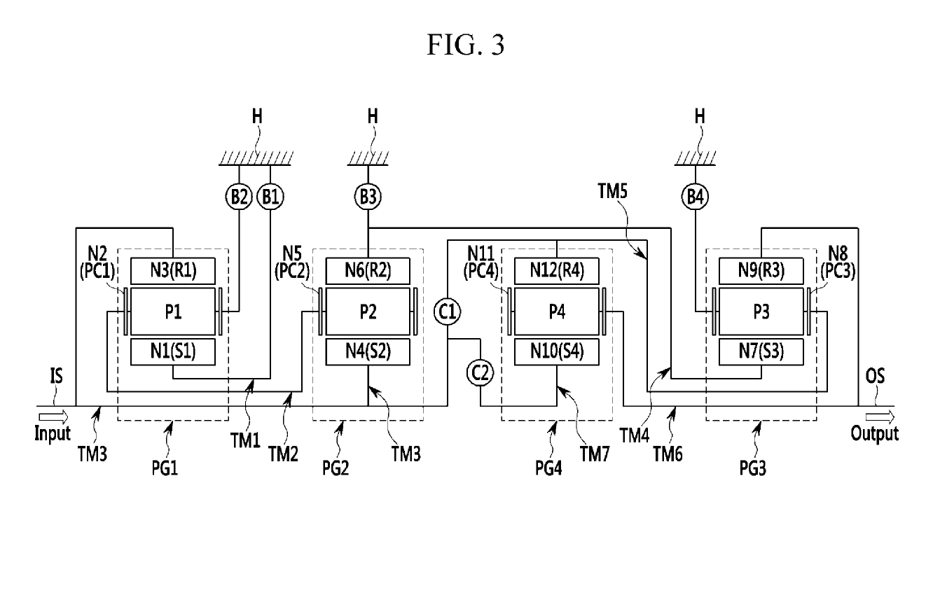

Although the planetary gear train according to the first exemplary embodiment as described above is configured in a layout in which it may be used in a rear-wheel drive vehicle by sequentially disposing the first, second, third, and fourth planetary gear sets PG1, PG2, PG3, and PG4 from the engine side to the rear, the planetary gear train is not limited thereto, but may be configured in a layout as illustrated in FIG. 3.

FIG. 3 is a schematic view of a planetary gear train according to a second exemplary embodiment of the present invention.

Referring to FIG. 3, although the planetary gear train is configured in the layout in which it may be used in the rear-wheel drive vehicle by sequentially disposing the first, second, third, and fourth planetary gear sets PG1, PG2, PG3, and PG4 from the engine side to the rear in the first exemplary embodiment, the first, second, fourth, and third planetary gear sets PG1, PG2, PG4, and PG3 are sequentially disposed in the second exemplary embodiment.

That is, shafts by the respective rotation elements, connection relationships between the shafts, and a shifting process of the planetary gear train according to a second exemplary embodiment are the same as those of the planetary gear train according to the first exemplary embodiment except for a disposition sequence of the third planetary gear set PG3 and the fourth planetary gear set PG4, and thus, a detailed description therefor will be omitted.

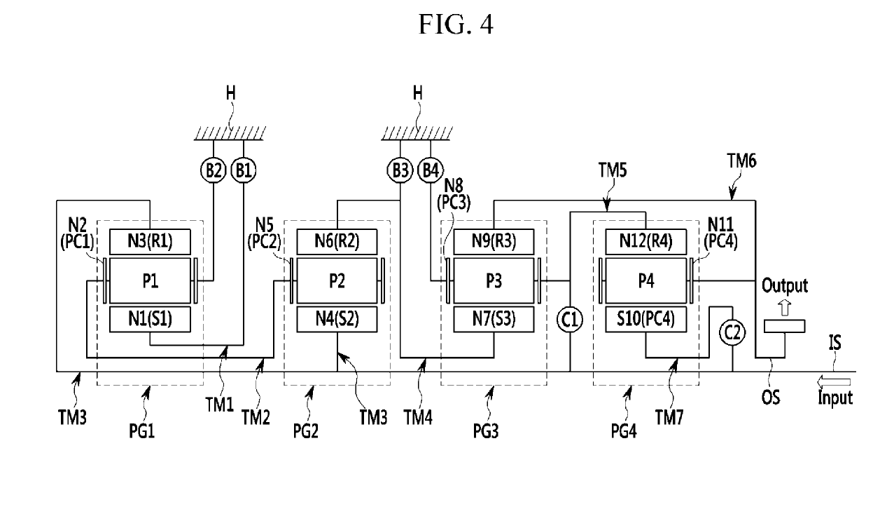

FIG. 4 is a schematic view of a planetary gear train according to a third exemplary embodiment of the present invention.

Referring to FIG. 4, although a layout is configured under the assumption that the rotation power of the engine is input from the first planetary gear set PG1 and is output to the rear of the fourth planetary gear set PG4 in the planetary gear train according to the first exemplary embodiment, a layout is configured so that an input and an output are made in the fourth planetary gear set PG4 in the third exemplary embodiment.

That is, the four planetary gear sets PG1 to PG4 and the six control elements C1 and C2 and B1 to B4 are configured to be the same as those of the first exemplary embodiment, the input shaft IS of the fourth planetary gear set PG4 is extended to be connected to an output side of the engine, and the output shaft OS is disposed at an external circumference of the input shaft IS to allow an input and an output to be made, such that the planetary gear train may be used in a front-wheel drive vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A planetary gear train of an automatic transmission for a vehicle, comprising:
an input shaft receiving power of an engine;
an output shaft outputting shifted power;
a first planetary gear set including a first rotation element, a second rotation element, and a third rotation element;
a second planetary gear set including a fourth rotation element, a fifth rotation element, and a sixth rotation element;
a third planetary gear set including a seventh rotation element, an eighth rotation element, and a ninth rotation element;
a fourth planetary gear set including a tenth rotation element, an eleventh rotation element, and a twelfth rotation element;
six control elements disposed at positions to selectively connect the rotation elements to each other or positions to selectively connect at least one of the rotation elements and a transmission housing to each other;
a first shaft connected to the first rotation element and selectively connectable to the transmission housing;
a second shaft connected to the second rotation element and the fifth rotation element and selectively connectable to the transmission housing;
a third shaft connected to the third rotation element and the fourth rotation element, and directly connected to the input shaft;
a fourth shaft connected to the sixth rotation element and the seventh rotation element, and selectively connectable to the transmission housing;
a fifth shaft connected to the eighth rotation element and the twelfth rotation element, selectively connectable to the third shaft, and selectively connectable to the transmission housing;
a sixth shaft connected to the ninth rotation element and the eleventh rotation element, and directly connected to the output shaft; and
a seventh shaft connected to the tenth rotation element and selectively connectable to the third shaft.

2. The planetary gear train of the automatic transmission for the vehicle of claim 1, wherein
in the first planetary gear set comprising a single pinion planetary gear set, the first rotation element is a first sun gear, the second rotation element is a first planet carrier, and the third rotation element is a first ring gear;
in the second planetary gear set comprising a single pinion planetary gear set, the fourth rotation element is a second sun gear, the fifth rotation element is a second planet carrier, and the sixth rotation element is a second ring gear;
in the third planetary gear set comprising a single pinion planetary gear set, the seventh rotation element is a third sun gear, the eighth rotation element is a third planet carrier, and the ninth rotation element is a third ring gear; and
in the fourth planetary gear set comprising a single pinion planetary gear set, the tenth rotation element is a fourth sun gear, the eleventh rotation element is a fourth planet carrier, and the twelfth rotation element is a fourth ring gear.

3. The planetary gear train of the automatic transmission for the vehicle of claim 1, wherein the six control elements include:
a first clutch selectively connecting the third shaft and the fifth shaft to each other;
a second clutch selectively connecting the third shaft and the seventh shaft to each other;
a first brake selectively connecting the first shaft and the transmission housing to each other;
a second brake selectively connecting the second shaft and the transmission housing to each other;
a third brake selectively connecting the fourth shaft and the transmission housing to each other; and
a fourth brake selectively connecting the fifth shaft and the transmission housing to each other.

4. The planetary gear train of the automatic transmission for the vehicle of claim 3, wherein shift-stages implemented by selective operation of two of the six control elements include:
a first forward shift-stage implemented by operation of the second and fourth brakes;
a second forward shift-stage implemented by operation of the second clutch and the fourth brake;
a third forward shift-stage implemented by operation of the second clutch and the second brake;
a fourth forward shift-stage implemented by operation of the second clutch and the third brake;
a fifth forward shift-stage implemented by operation of the second clutch and the first brake;
a sixth forward shift-stage implemented by operation of the first and second clutches;
a seventh forward shift-stage implemented by operation of the first clutch and the first brake;
an eighth forward shift-stage implemented by operation of the first clutch and the third brake;
a ninth forward shift-stage implemented by operation of the first clutch and the second brake; and
a reverse shift implemented by operation of the first and fourth brakes.

5. The planetary gear train of the automatic transmission for the vehicle of claim 1, wherein the first, second, third, and fourth planetary gear sets are disposed in a sequence of the first, second, third, and fourth planetary gear sets, and the shafts are disposed so that an input is made from a front of the first planetary gear set and an output is made to a rear of the fourth planetary gear set.

6. The planetary gear train of the automatic transmission for the vehicle of claim 1, wherein the first, second, third, and fourth planetary gear sets are disposed in a sequence of the first, second, fourth, and third planetary gear sets, and are configured so that an input is made from a front of the first planetary gear set and an output is made to a rear of the third planetary gear set.

7. The planetary gear train of the automatic transmission for the vehicle of claim 1, wherein the first, second, third, and fourth planetary gear sets are disposed in a sequence of the first, second, third, and fourth planetary gear sets, and are configured so that an input and an output are made in the fourth planetary gear set.

8. A planetary gear train of an automatic transmission for a vehicle, comprising:
an input shaft receiving power of an engine;
an output shaft outputting shifted power;
a first planetary gear set comprising a single pinion planetary gear set and including a first rotation element, a second rotation element, and a third rotation element;
a second planetary gear set comprising a single pinion planetary gear set and including a fourth rotation element, a fifth rotation element, and a sixth rotation element;
a third planetary gear set comprising a single pinion planetary gear set and including a seventh rotation element, an eighth rotation element, and a ninth rotation element;
a fourth planetary gear set comprising a single pinion planetary gear set and including a tenth rotation element, an eleventh rotation element, and a twelfth rotation element;
a first shaft connected to the first rotation element and selectively connectable to a transmission housing;
a second shaft connected to the second rotation element and the fifth rotation element and selectively connectable to the transmission housing;
a third shaft connected to the third rotation element and the fourth rotation element and directly connected to the input shaft;
a fourth shaft connected to the sixth rotation element and the seventh rotation element and selectively connectable to the transmission housing;
a fifth shaft connected to the eighth rotation element and the twelfth rotation element, selectively connectable to the third shaft, and selectively connectable to the transmission housing;
a sixth shaft connected to the ninth rotation element and the eleventh rotation element and directly connected to the output shaft;
a seventh shaft connected to the tenth rotation element and selectively connectable to the third shaft;
a first clutch selectively connecting the third shaft and the fifth shaft to each other;
a second clutch selectively connecting the third shaft and the seventh shaft to each other;
a first brake selectively connecting the first shaft and the transmission housing to each other;
a second brake selectively connecting the second shaft and the transmission housing to each other;
a third brake selectively connecting the fourth shaft and the transmission housing to each other; and
a fourth brake selectively connecting the fifth shaft and the transmission housing to each other.

9. The planetary gear train of the automatic transmission for the vehicle of claim 8, wherein
in the first planetary gear set, the first rotation element is a first sun gear, the second rotation element is a first planet carrier, and the third rotation element is a first ring gear;
in the second planetary gear set, the fourth rotation element is a second sun gear, the fifth rotation element is a second planet carrier, and the sixth rotation element is a second ring gear;
in the third planetary gear set, the seventh rotation element is a third sun gear, the eighth rotation element is a third planet carrier, and the ninth rotation element is a third ring gear; and
in the fourth planetary gear set, the tenth rotation element is a fourth sun gear, the eleventh rotation element is a fourth planet carrier, and the twelfth rotation element is a fourth ring gear.

10. The planetary gear train of the automatic transmission for the vehicle of claim 8, wherein shift-stages implemented by a selective operation of two of control elements including the two clutches and the four brakes include:
a first forward shift-stage implemented by operation of the second and fourth brakes;
a second forward shift-stage implemented by operation of the second clutch and the fourth brake;
a third forward shift-stage implemented by operation of the second clutch and the second brake;
a fourth forward shift-stage implemented by operation of the second clutch and the third brake;
a fifth forward shift-stage implemented by operation of the second clutch and the first brake;
a sixth forward shift-stage implemented by operation of the first and second clutches;
a seventh forward shift-stage implemented by operation of the first clutch and the first brake;
an eighth forward shift-stage implemented by operation of the first clutch and the third brake;
a ninth forward shift-stage implemented by operation of the first clutch and the second brake; and
a reverse shift implemented by operation of the first and fourth brakes.

11. The planetary gear train of the automatic transmission for the vehicle of claim 10, wherein the first, second, third, and fourth planetary gear sets are disposed in a sequence of the first, second, third, and fourth planetary gear sets, and the shafts are disposed so that an input is made from a front of the first planetary gear set and an output is made to a rear of the fourth planetary gear set.

12. The planetary gear train of the automatic transmission for the vehicle of claim 10, wherein the first, second, third, and fourth planetary gear sets are disposed in a sequence of the first, second, fourth, and third planetary gear sets, and are configured so that an input is made from a front of the first planetary gear set and an output is made to a rear of the third planetary gear set.

13. The planetary gear train of the automatic transmission for the vehicle of claim 10, wherein the first, second, third, and fourth planetary gear sets are disposed in a sequence of the first, second, third, and fourth planetary gear sets, and are configured so that an input and an output are made in the fourth planetary gear set.

14. A planetary gear train of an automatic transmission for a vehicle, comprising:
an input shaft receiving power of an engine;
an output shaft outputting shifted power;
a first planetary gear set being a single pinion planetary gear set including a first sun gear, a first planet carrier, and a first ring gear;
a second planetary gear set being a single pinion planetary gear set including a second sun gear, a second planet carrier, and a second ring gear;
a third planetary gear set being a single pinion planetary gear set including a third sun gear, a third planet carrier, and a third ring gear;
a fourth planetary gear set being a single pinion planetary gear set including a fourth sun gear, a fourth planet carrier, and a fourth ring gear;
a first shaft connected to the first sun gear and selectively connectable to a transmission housing;
a second shaft connected to the first planet carrier and the second planet carrier and selectively connectable to the transmission housing;
a third shaft connected to the first ring gear and the second sun gear and directly connected to the input shaft;
a fourth shaft connected to the second ring gear and the third sun gear and selectively connectable to the transmission housing;
a fifth shaft connected to the third planet carrier and the fourth ring gear, selectively connectable to the third shaft, and selectively connectable to the transmission housing;
a sixth shaft connected to the third ring gear and the fourth planet carrier and directly connected to the output shaft;
a seventh shaft connected to the fourth sun gear and selectively connectable to the third shaft; and
six control elements disposed at positions to selectively connect the shafts to each other and at positions to selectively connect at least one of the shafts and the transmission housing to each other.

15. The planetary gear train of the automatic transmission for the vehicle of claim 14, wherein the six control elements include:
a first clutch selectively connecting the third shaft and the fifth shaft to each other;
a second clutch selectively connecting the third shaft and the seventh shaft to each other;
a first brake selectively connecting the first shaft and the transmission housing to each other;
a second brake selectively connecting the second shaft and the transmission housing to each other;
a third brake selectively connecting the fourth shaft and the transmission housing to each other; and
a fourth brake selectively connecting the fifth shaft and the transmission housing to each other.

16. The planetary gear train of the automatic transmission for the vehicle of claim 15, wherein shift-stages implemented by a selective operation of two of the six control elements include:
a first forward shift-stage implemented by operation of the second and fourth brakes;
a second forward shift-stage implemented by operation of the second clutch and the fourth brake;
a third forward shift-stage implemented by operation of the second clutch and the second brake;
a fourth forward shift-stage implemented by operation of the second clutch and the third brake;
a fifth forward shift-stage implemented by operation of the second clutch and the first brake;
a sixth forward shift-stage implemented by operation of the first and second clutches;
a seventh forward shift-stage implemented by operation of the first clutch and the first brake;
an eighth forward shift-stage implemented by operation of the first clutch and the third brake;
a ninth forward shift-stage implemented by operation of the first clutch and the second brake; and
a reverse shift implemented by operation of the first and fourth brakes.

17. The planetary gear train of the automatic transmission for the vehicle of claim 14, wherein the first, second, third, and fourth planetary gear sets are disposed in a sequence of the first, second, third, and fourth planetary gear sets, and the shafts are disposed so that an input is made from a front of the first planetary gear set and an output is made to a rear of the fourth planetary gear set.

18. The planetary gear train of the automatic transmission for the vehicle of claim 14, wherein the first, second, third, and fourth planetary gear sets are disposed in a sequence of the first, second, fourth, and third planetary gear sets, and are configured so that an input is made from a front of the first planetary gear set and an output is made to a rear of the third planetary gear set.

19. The planetary gear train of the automatic transmission for the vehicle of claim 14, wherein the first, second, third, and fourth planetary gear sets are disposed in a sequence of the first, second, third, and fourth planetary gear sets, and are configured so that an input and an output are made in the fourth planetary gear set.
